(19) United States
(12) Patent Application Publication
(10) Pub. No.: US 2018/0081875 A1
(43) Pub. Date: Mar. 22, 2018

(54) MULTILINGUAL TRANSLATION AND PREDICTION DEVICE AND METHOD THEREOF

(71) Applicant: Samsung Electronics Co., Ltd., Gyeonggi-do (KR)

(72) Inventors: Kim Tung Le, Thanh Hoa City (VN); Quang Long Nguyen, Nam Sach Dist (VN)

(21) Appl. No.: 15/709,375

(22) Filed: Sep. 19, 2017

(30) Foreign Application Priority Data
Sep. 19, 2016 (KR) 10-2016-0119562

(51) Int. Cl. G06F 17/28; G06F 3/0482; G06F 3/0488

(52) U.S. Cl. CPC G06F 17/289; G06F 3/0488; G06F 3/0482

(57) ABSTRACT

A method for of predicting and translating words includes receiving characters of a first language. The method also includes predicting one or more recommended words of a first language based on the received characters. Additionally the method includes obtaining one or more recommended words of a second language by translating the predicted recommended words of the first language. The method also includes displaying the one or more recommended words of the first language and the one or more recommended words of the second language.

### CROSS-REFERENCE TO RELATED APPLICATION AND CLAIM OF PRIORITY

This application is related to and claims priority to Korean Patent Application No. 10-2016-0119562 filed on Sep. 19, 2016, the contents of which are incorporated herein by reference.

### TECHNICAL FIELD

The present disclosure relates to a multilingual translation and prediction device and a method thereof.

### BACKGROUND

Use of various languages for communication and work has considerably increased. English is a widely used global language, but not all countries use English as an official language and people may use English and their mother tongue at the same time. People can create electronic content in various text languages, but the number of characters may vary depending on the language is used. Also, some languages may include special characters (for example, Chinese or Korean characters) that require a special input method editor (IME) input system.

Currently, smartphones include a dictionary function, but since a method of inputting words is separated from the dictionary function, it takes a lot of time and unnecessary effort to convert, copy, and paste words into the dictionary when users want to use the dictionary.

### SUMMARY

For example, when a user types a word on a smartphone, the smartphone may predict the word according to a selected input language, and if the user wants to translate the word, the user has to click on the word for a long period of time and then select a dictionary icon to translate the word. These process series are inconvenient because they are not executed simultaneously with the user's typing.

To address the above-discussed deficiencies, it is a primary object to provide a multilingual translation and prediction device and a method of predicting a word based on characters input by a user types a word, translating the predicted word and simultaneously displaying the predicted word and the translated word, thereby instantly providing the predicted word and the translated word to the user.

Additional aspects will be set forth in part in the description which follows and, in part, will be apparent from the description, or may be learned by practice of the presented example embodiments.

According to an aspect of an example embodiment, a method of predicting and translating words includes: receiving characters of a first language; predicting one or more recommended words of a first language based on the received characters; obtaining one or more recommended words of a second language by translating the predicted recommended words of the first language; and displaying the one or more recommended words of the first language and the one or more recommended words of the second language.

The obtaining of the one or more recommended words of the second language may further include: calculating a priority of the one or more recommended words of the second language; and providing the one or more recommended words of the second language by aligning them according to the calculated priority.

The one or more recommended words of the first language and the one or more recommended words of the second language may be simultaneously displayed.

The method of predicting and translating words may further include: selecting the first and second languages.

The selecting of the first and second languages may include: determining subsets of a combination of the first and second languages according to a predetermined setting.

The predicting of the one or more recommended words of the first language based on the received characters may include providing the recommended words of the first language in a complete form when the received characters include incomplete characters.

The providing of the recommended words of the second language may include: providing one or more recommended words of a third language by translating the recommended words of the second language, and the displaying of the one or more recommended words of the first language and the one or more recommended words of the second language may include: displaying the one or more recommended words of the third language.

The one or more recommended words of the first language, the one or more recommended words of the second language, and the one or more recommended words of the third language may be simultaneously displayed.

According to an aspect of an example embodiment, a device for predicting and translating words includes: an input unit configured to receive characters of a first language; a controller configured to predict one or more recommended words of the first language based on the received characters, and to obtain one or more recommended words of a second language by translating the predicted recommended words of the first language; and a display unit configured to display the one or more recommended words of the first language and the one or more recommended words of the second language.

The controller may calculate priority of the one or more recommended words of the second language, and may provide the one or more recommended words of the second language by aligning them according to the calculated priority.

The display unit may simultaneously display the one or more recommended words of the first language and the one or more recommended words of the second language.

The controller may select the first language and the second language based on an external input.

The device for predicting and translating words may further include: a storage configured to store subsets of a combination of the first and second languages, wherein the controller may determine the subsets of the combination of the first and second languages according to a predetermined setting.

The controller may provide the recommended words of the first language in a complete form when the received characters include incomplete characters.

The controller may provide one or more recommended words of a third language by translating the recommended words of the second language, and the display unit may display the one or more recommended words of the third language.

The one or more recommended words of the first language, the one or more recommended words of the second language, and the one or more recommended words of the third language may be simultaneously displayed.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a flowchart of a method for predicting and translating words according to an example embodiment of the present disclosure;

FIG. 2 illustrates a flowchart of a method for calculating a priority of recommended words and providing the recommended words aligned according to the priority, according to an example embodiment of the present disclosure;

FIG. 3 illustrates a flowchart of a method for simultaneously displaying a predicted word and a translated word, according to an example embodiment of the present disclosure;

FIG. 4 illustrates a flowchart of a method for predicting and translating words by selecting a first language and a second language, according to an example embodiment of the present disclosure;

FIG. 5 illustrates a view of subsets of a first language and a second language according to a predetermined configuration, according to an example embodiment of the present disclosure;

FIG. 6 illustrates a flowchart of a method for providing a recommended word in a complete form corresponding to incomplete characters when the incomplete characters are detected from input characters, according to an example embodiment of the present disclosure;

FIG. 7 illustrates a flowchart of a method for predicting and translating words of first, second, and third languages, according to an example embodiment of the present disclosure;

FIG. 8 illustrates a flowchart of a method for simultaneously displaying predicted word of a first language and translated recommended words of second, and third languages, according to an example embodiment of the present disclosure;

FIG. 9 illustrates a functional block diagram for predicting and translating words according to an example embodiment of the present disclosure;

FIG. 10 illustrates a functional block diagram of a device for predicting and translating words and an apparatus to which the device is connected and/or installed, according to an example embodiment of the present disclosure;

FIG. 11 illustrates a view of an example of calculating a priority of recommended words and providing the recommended words aligned according to the priority, according to an embodiment of the present disclosure;

FIG. 12 illustrates a view of an example of simultaneously displaying predicted words and translated words, according to an example embodiment of the present disclosure;

FIG. 13 illustrates a view of a configuration for displaying predicted words on a device on which characters are input and displaying translated words on an apparatus connected and/or installed to the device, according to an example embodiment of the present disclosure;

FIG. 14 illustrates a view of a configuration for displaying some predicted words and translated words on a device on which characters are input and displaying other predicted words and translated words on an apparatus connected and/or installed to the device, according to an example embodiment of the present disclosure;

FIG. 15 illustrates a view of an example of selecting a first language and a second language based on an external input, according to an example embodiment of the present disclosure;

FIG. 16 illustrates a functional block diagram of a view of a device for predicting and translating words, the device including a storage for storing subsets of a first language and a second language, according to an example embodiment;

FIG. 17 illustrates a view of an example of providing recommended words in a complete form corresponding to incomplete characters when the incomplete characters are included in input characters, according to an example embodiment;

FIG. 18 illustrates a view of an example of predicting and translating words of first, second, and third languages;

FIG. 19 illustrates a view of an example of simultaneously displaying predicted words and translated words of first, second, and third languages;

FIG. 20 illustrates a view of a configuration for displaying predicted words on a device on which characters are input and displaying translated words on an apparatus connected and/or installed to the device; and

FIG. 21 illustrates a view of a configuration for displaying some predicted words and translated words on a device on which characters are input and displaying other predicted words and translated words on an apparatus connected and/or installed to the device.

### DETAILED DESCRIPTION

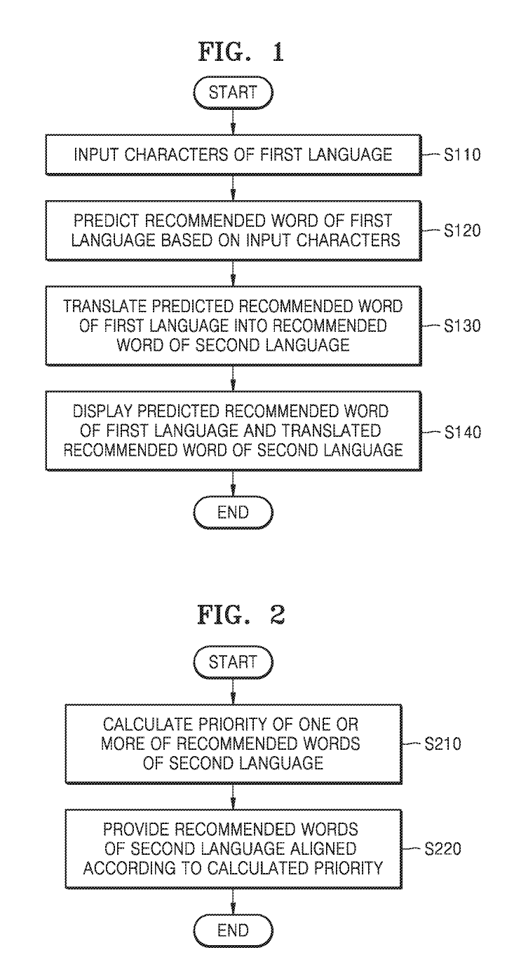

FIGS. 1 through 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Throughout the specification, it will be understood that when a unit is referred to as being “connected” to another element, it may be “directly connected” to the other element or “electrically connected” to the other element in a state in which intervening elements are present. In addition, it will be understood that when a unit is referred to as “comprising” another element, it may not exclude the other element but may further include the other element unless specifically oppositely indicated.

In addition, in the present specification, a device may be, but is not limited thereto, various electronic devices and mobile or non-mobile computing devices such as a television (TV), a tablet personal computer (PC), a digital camera, a camcorder, a laptop computer, a desktop computer, an electronic book terminal, a terminal for digital broadcasting, a personal digital assistant (PDA), a portable multimedia player (PMA), a navigation, an MP3 player, a wearable device, and the like. Also, the device may include various devices such as an electronic blackboard, a touch table, etc. that may receive a touch input.

Furthermore, in an example embodiment, the term “user” refers to a person who controls functions or operations related to an image by using a display device 100, and may include a viewer and a manager.

Hereinafter, a method of predicting and translating multiple languages according to the present example embodiment will be described with reference to drawings.

In the method of predicting and translating multiple languages according to the present example embodiment, recommended words of a first language are predicted based on input characters and recommended words of a second language by translating the recommended words of the first language are provided to a user, thereby being possible to display the recommended words of the first language and the recommended words of the second language.

FIG. 1 illustrates a flowchart of a method for predicting and translating words according to an example embodiment of the present disclosure.

In operation S110, characters of a first language may be input. The characters of the first language may be Korean characters, English characters, Japanese characters, Chinese characters, French characters, German characters, Greek characters, Spanish characters, and the like. The characters may be input externally via, for example, a keyboard, a mouse, a touch, voice recognition, and the like.

In operation S120, based on the input characters of the first language, a recommended word of the same language may be predicted. The prediction of the recommended word may include a synonym prediction, a similar word prediction, and an antonym prediction. In addition, the prediction of the recommended word may include a prediction of shapes of characters, a prediction of a postposition at the ending of characters (termination of the characters), and the like, according to a grammar of a corresponding language.

In operation S130, the predicted recommended word of the first language may be translated into a recommended word of a second language. The second language may be different from the first language. For example, if the first language is Korean, the second language may be any other language except Korean. The translation into the recommended word of the second language may be a translation of at least one synonym, or a translation of one or more synonyms and/or similar words.

In operation S140, the predicted recommended word of the first language and the translated recommended word of the second language may be displayed. The predicted recommended word or more than one predicted word of the first language may be displayed according to a predetermined setting, and the translated recommended word or more than one translated recommended word of the second language may also be displayed according to a predetermined setting. According to an example embodiment, the predicted recommended word of the first language and the translated recommended word of the second language are preferably displayed on a single display screen.

According to an example embodiment, the term displayed may mean that the predicted recommended word of the first language and the translated recommended word of the second language are displayed on a display unit included in a device or displayed on a display unit included in an external device connected and/or installed to a device using the method. The external device connected and/or installed to the device may include a TV, a tablet PC, a laptop computer, a wearable device, and the like.

FIG. 2 illustrates a flowchart of a method for calculating a priority of recommended words of a second language and providing the recommended words aligned according to a priority, according to an example embodiment of the present disclosure.

In operation S210, a priority of one or more of the recommended words of the second language by translating the recommended words of the first language may be calculated. The calculation of the priority may include calculation based on a user's preference history, calculation by synthesizing preference histories of not only a user of a device but also all users of other devices, calculation based on a predetermined setting stored in an environment setting, and the like.

In operation S220, the recommended words of the second language may be aligned and provided according to the calculated priority. The providing of the alignment of the recommended words of the second language may include providing of a list including one or more recommended words.

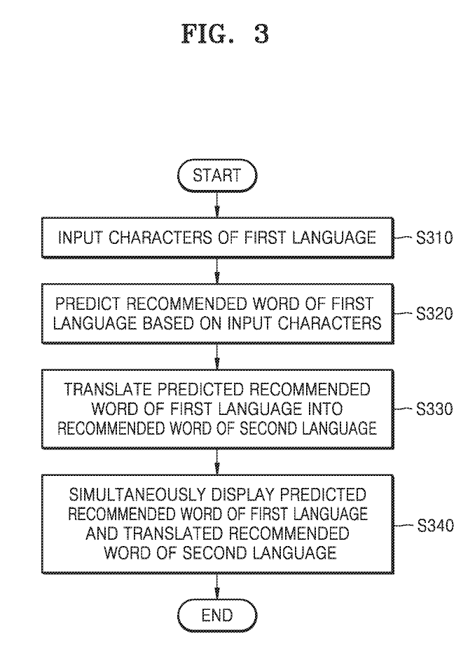

FIG. 3 illustrates a flowchart for simultaneously displaying a predicted recommended word of a first language and a translated recommended word of a second language, according to an example embodiment of the present disclosure.

Since a feature of receiving characters of the first language, predicting the recommended words of the first language, and translating the recommended words of the second language in operations S310 to S330 has been described above with reference to operations S110 to S130 of FIG. 1, a detailed description thereof will not be given herein.

In operation S340, the predicted recommended word of the first language and the translated recommended word of the second language may be simultaneously displayed. According to an example embodiment, the terminology simultaneously displayed may mean that the predicted recommended word of the first language and the translated recommended word of the second language are simultaneously displayed on an identical screen. Furthermore, the terminology simultaneously displayed may mean that the predicted recommended word of the first language is displayed on a display unit of a device to which words are input and the recommended word of the second language is displayed at the same time on a display unit of a device connected and/or installed to the device to which words are input. Alternatively, the terminology simultaneously displayed may mean that one or more of the recommended words of the first language and one or more of the recommended words of the second language are displayed on a display unit of a device on which words are input, and the other recommended words of the first and second languages are displayed at the same time on a display unit of a device connected and/or installed to the device to which words are input.

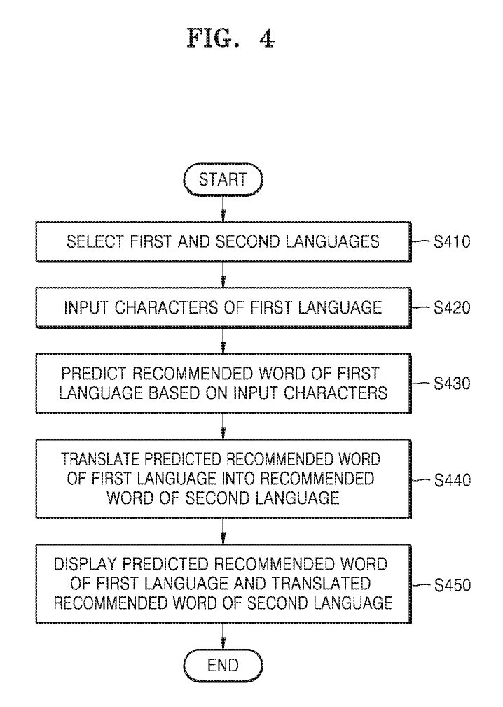

FIG. 4 illustrates a flowchart of a process for predicting and translating words by selecting a first and second language, according to an example embodiment of the present disclosure. For example, FIG. 4 illustrates a flowchart for displaying the predicted recommended word of the first language and a translated recommended word of the second language.

In operation S410, the first and second languages may be selected. The selection of the first and second languages may include selection based on an external input, selection based on a predetermined setting, and the like. The external input may include input by a keyboard, input by a mouse, input by a touch, input by voice recognition, and the like. The predetermined setting may include a setting based on a default language set in a device, a user-specified setting for each application, a setting changed depending on a specific environment (for example, while roaming, a language of the device is changed to a language of a country where the roaming is performed), and the like.

Since a feature of receiving characters of the first language, predicting the recommended words of the first language, and translating the recommended words of the second language in operations S420 to S450 has been described above with reference to operations S110 to S130 of FIG. 1, a detailed description thereof will not be given herein.

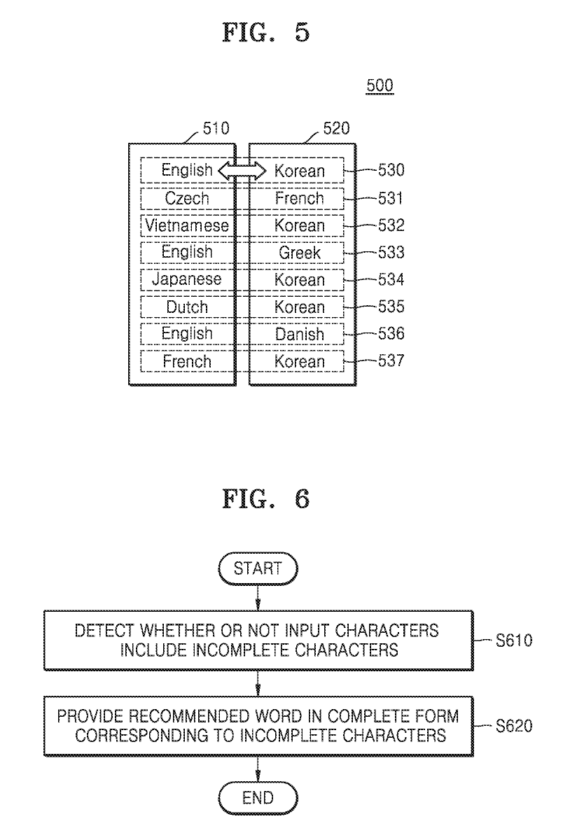

FIG. 5 illustrates a view of subsets of a first language and a second language according to a predetermined configuration, according to an example embodiment of the present disclosure. For example, FIG. 5 illustrates a configuration for selecting a first language and a second language by determining subsets of a combination of the first and second languages stored according to a predetermined setting, according to an example embodiment.

A first language 510 may be English, Czech, Vietnamese, Japanese, Japanese, German, or French. The second language 520 may be Korean, French, Greek, or Danish. The first language 510 is not the same as the second language 520. The first language 510 and the second language 520 may be configured via subsets with different combinations of the respective languages. For example, a first subset 530 may select English as the first language and Korean as the second language, a second subset 531 may select Czech as the first language and French as the second language, a third subset 532 may select Vietnamese as the first language and Korean as a second language, a fourth subset 533 may select English as a first language and Greek as the second language, a fifth subset 534 may select Japanese as the first language and Korean as the second language, a sixth subset 535 may select German as the first language and Korean as the second language, a seventh subset 536 may select English as the first language and Danish as the second language, and an eighth subset 537 may select French as the first language and Korean as the second language. For example, a user may select one of the first to eighth subsets to determine a language to be predicted and a language to be translated.

FIG. 6 illustrates a flowchart of a method for providing a recommended word in a complete form corresponding to incomplete characters when the incomplete characters are detected from input characters, according to an example embodiment of the present disclosure.

In operation S610, it is detected whether or not the input characters include incomplete characters. The incomplete characters may include characters in a case where only a consonant or a vowel is input in Korean, a case where a combination of characters is incomplete when the characters are input on a mobile device, a case where characters not included in a database are input, and the like.

In operation S620, a recommended word in a complete form corresponding to the incomplete characters is provided to the input characters. The recommended word in a complete form may be provided by completing only the recommended word, provided in a plurality of forms according to a grammar of the language, or may be provided together with postpositions according to a grammar and a form of a sentence of the language.

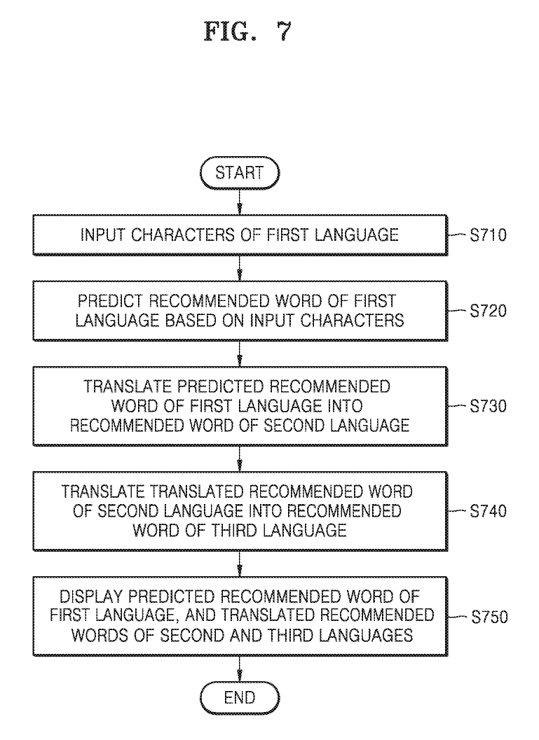

FIG. 7 illustrates a flowchart for predicting and translating words of first, second, and third languages, according to an example embodiment of the present disclosure. For example, FIG. 7 illustrates a process of obtaining a recommended word of a second language translated according to an example embodiment, and translating the obtained recommended word of the second language and a recommended word of a third language.

Since a feature of receiving characters of the first language, predicting the recommended words of the first language, and translating the recommended words of the second language in operations S710 to S730 has been described above with reference to operations S110 to S130 of FIG. 1, a detailed description thereof will not be given herein.

In operation S740, the translated recommended word of the second language may be translated into the recommended word of the third language. The third language is different from the first and second languages. For example, if the first language is Korean and the second language is English, the third language may be a language of all countries except Korean and English. The translation into the recommended word of the third language may be a translation of at least one synonym, or a translation of one or more synonyms and/or similar words.

In operation S750, the predicted recommended word of the first language, the translated recommended word of the second language, and the translated recommended word of the third language may be displayed. The predicted recommended word of the first language may be displayed according to a predetermined setting, and at least one of the translated recommended words of the second and third languages may also be displayed according to a predetermined setting. In addition, the predicted recommended word of the first language and the translated recommended words of the second and third languages are preferably displayed on a single display screen.

Furthermore, according to an example embodiment, the term displaying may mean displaying on a display unit included in a device, or displaying on a display unit included in an external device connected and/or installed to a device. The external device connected and/or installed to the device may include a TV, a tablet PC, a laptop computer, a wearable device, and the like. For example, while the predicted recommended word of the first language and the translated recommended word of the second language are displayed on the display unit included in the device, the translated recommended word of the third language may be displayed on a display unit included in a wearable device.

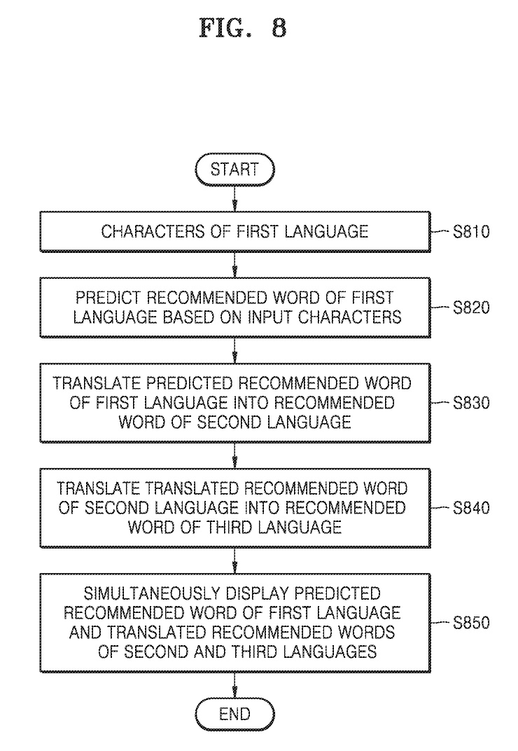

FIG. 8 illustrates a flowchart for simultaneously displaying a predicted word of a first language and translated recommended words of second and third languages, according to an example embodiment.

Since a feature of receiving characters of the first language, predicting the recommended words of the first language, translating the recommended words of the second language, and translating the recommended words of the third language in operations S810 to S840 has been described above with reference to operations S710 to S740 of FIG. 7, a detailed description thereof will not be given herein.

In operation S850, the predicted recommended word of the first language and the translated recommended words of the second and third languages may be simultaneously displayed. According to an embodiment, the terminology simultaneous displaying may include simultaneously displaying the predicted recommended word of the first language and the translated recommended words of the second and third languages on an identical screen. Furthermore, simultaneous displaying may mean displaying the predicted recommended word of the first language on a display unit of a device to which words are input, and displaying at the same time the recommended words of the second language on a display unit of a device connected and/or installed to the device to which words are input. For example, when a user wants to translate and display the recommended words of the second and third languages corresponding to the predicted recommended word of the first language, a space on the display unit included in the device is narrow, so that some translated recommended words may be displayed on a display unit included in an external device connected and/or installed to the device.

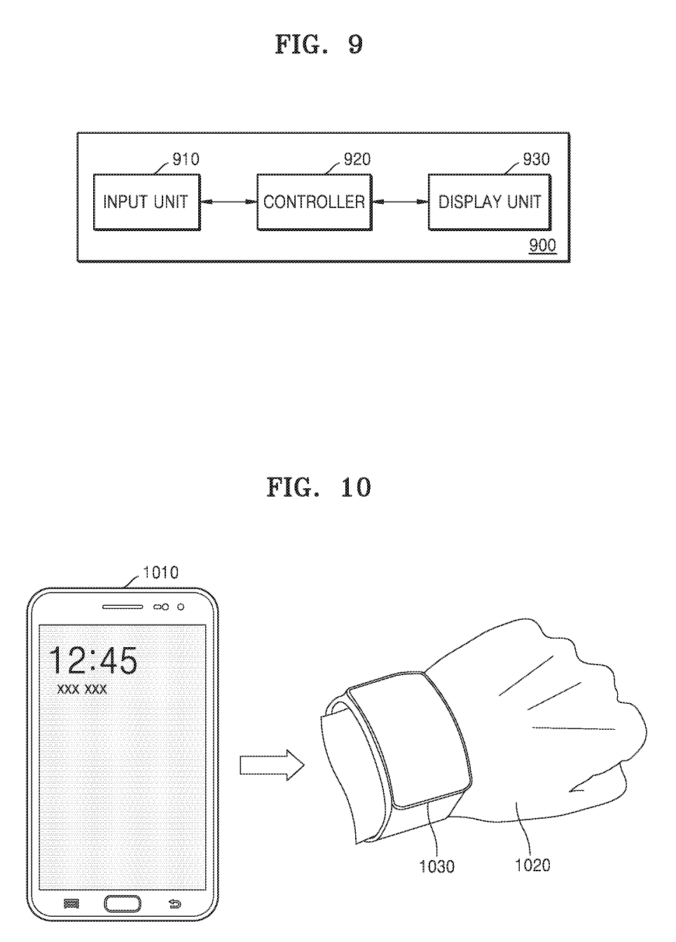

FIG. 9 illustrates a functional block diagram of a configuration of a device 900 for predicting and translating words, according to an embodiment of the present disclosure.

As illustrated in FIG. 9, the device 900 for predicting and translating words may include an input unit 910, a controller 920, and a display unit 930. However, the device 900 for predicting and translating words may be implemented via more or less components than those shown in FIG. 9.

Referring to FIG. 9, the device 900 for predicting and translating words may include the input unit 910 for receiving input by a keyboard, input by a mouse, input by a touch, and input by voice recognition, the controller 920 for receiving at least one of information on a selection of a language country where the device 900 is used, information on clicking recommended word in a recommended word list, and word input information, and predicting and translating recommended words, and a display unit 930 for displaying the recommended words translated and predicted by the controller 920 in a service screen.

The input by the input unit 910 may include input by a keyboard, input by a mouse, input by a touch, input by voice recognition, and the like.

The controller 920 is a hardware configuration implemented by at least one processor such as a Central Processing Unit (CPU), an Application Processor (AP), and the like, and may control general operations of the display device 100.

The controller 920 may select a language to be predicted and a language to be translated, may predict recommended words of input characters based on information stored in a database, may translate the predicted words into another language, and may transmit information about the predicted words and the translated words to the display unit to display the predicted words and translated words. In particular, the controller 920 may predict synonyms, similar words, antonyms, and the like corresponding to the recommended words, and may predict shapes of characters or postpositions of endings after characters according to a grammar of a corresponding language.

The display unit 930 displays the predicted word and translated words of the controller 920. The display unit 930 may be implemented as a plasma display panel (PDP), a liquid crystal display (LCD), an organic light emitting diode display (OLED), a flexible display, or the like, and may also be implemented as a three-dimensional (3D) display. Also, the display unit 930 may be configured as a touch screen and used as an input device in addition to an output device.

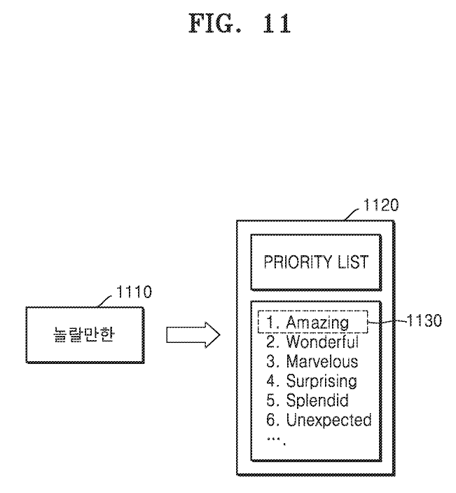

FIG. 10 illustrates a functional block diagram of a device for predicting and translating words and an apparatus to which the device is connected and/or installed, according to an example embodiment of the present disclosure. The display unit 930, of FIG. 9, may be a display unit 1030 of FIG. 10 included in an external device 1020 connected and/or installed to a device 1010.

FIG. 11 illustrates a view of an example of calculating a priority of recommended words and providing the recommended words aligned according to the priority, according to an embodiment of the present disclosure. Specifically, FIG. 11 is a block diagram of providing recommended words of a second language aligned according to a priority thereof, according to an example embodiment. For example, if a recommended word of a first language 1110 is in Korean and a second language 1130 is ‘English’, words corresponding to in English, which is the second language, are extracted to create a priority list 1120. Calculation of a priority of each of the extracted words may include calculation based on a user's preference history, calculation by synthesizing preference histories of not only a user of the device 1010 but all users of other devices, or calculation based on a predetermined setting stored in an environment setting.

After calculating the priority, the device 1010 may align recommended words of the second language (English) based on the calculated priority to provide a list 1130 including at least one recommended word.

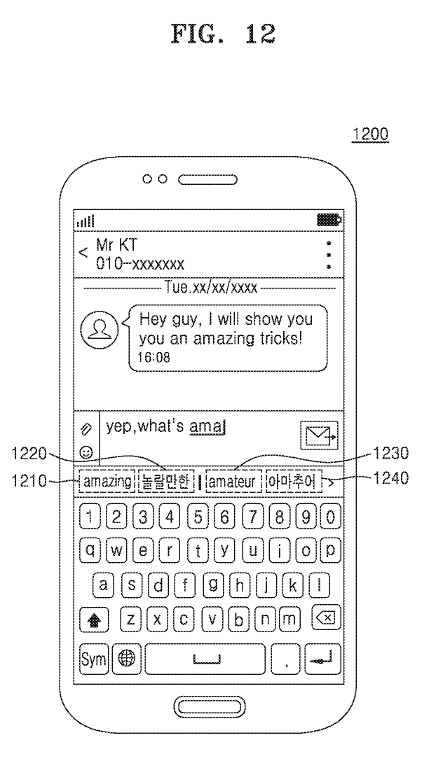

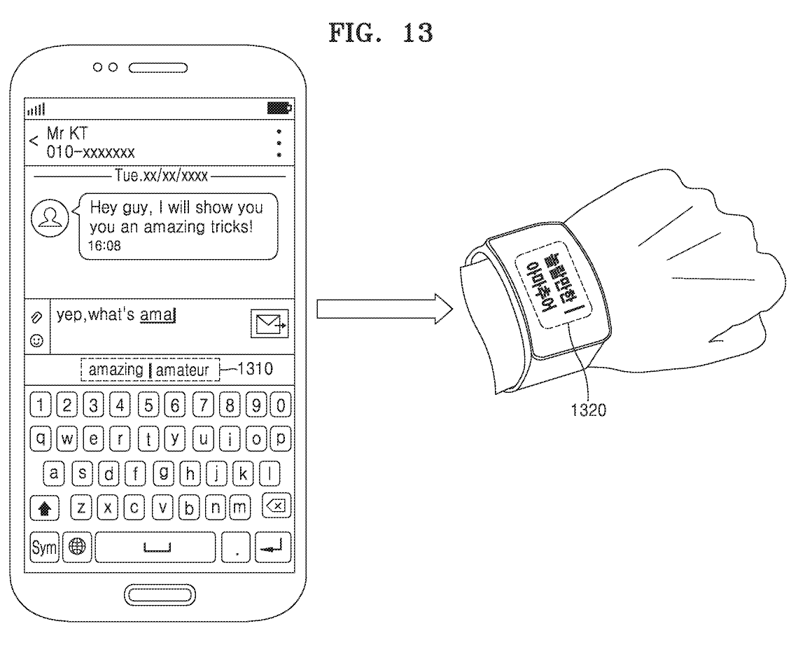

FIG. 12 illustrates a view of an example of simultaneously displaying predicted words and translated words, according to an embodiment of the present disclosure. For example FIG. 12 depicts simultaneously displaying predicted recommended words of a first language and translated recommended words of a second language, according to an example embodiment.

According to an example embodiment, a device 1200 may simultaneously display a predicted recommended word 1210 of the first language and a translated recommended word 1220 of the second language. According to an example embodiment, the terminology simultaneous displaying may mean simultaneously displaying a plurality of predicted recommended words 1210 and 1230 of the first language and a plurality of translated recommended words 1220 and 1240 of the second language on an identical screen.

FIG. 13 illustrates a view of a configuration for displaying predicted words on a device on which characters are input and displaying translated words on an apparatus connected and/or installed to the device, according to an embodiment of the present disclosure. According to an example embodiment, the terminology simultaneous displaying may mean displaying recommended words of the first language on a display unit 1310 of the device to which words are input, and displaying at the same time recommended words of the second language on a display unit 1320 of the device connected and/or installed to the device to which words are input.

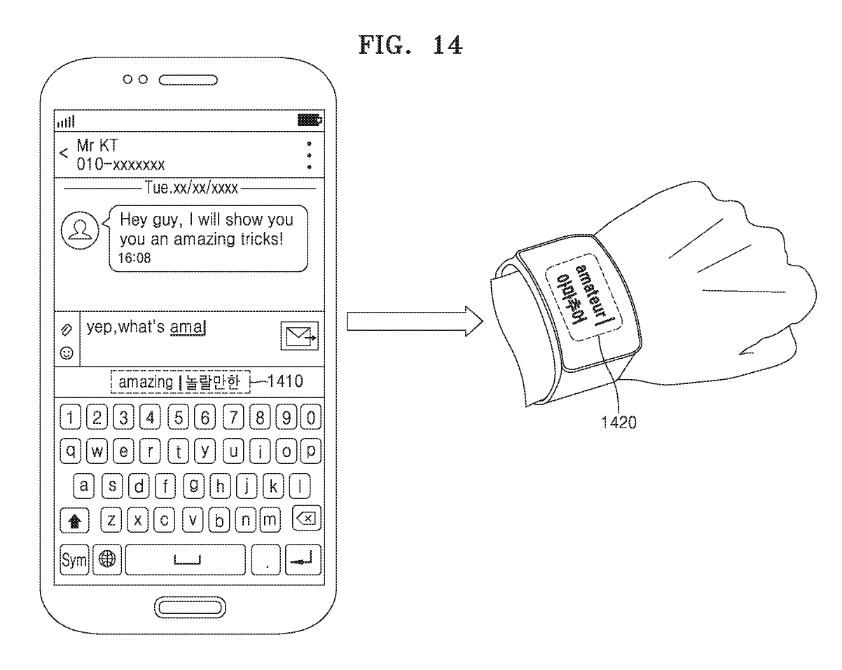

FIG. 14 illustrates a view of a configuration for displaying some predicted words and translated words on a device on which characters are input and displaying other predicted words and translated words on an apparatus connected and/or installed to the device, according to an embodiment of the present disclosure. According to an example embodiment, the terminology simultaneous displaying may include displaying at least one recommended word of the first language and at least one recommended word of the second language on a display unit 1410 of the device on which words are input, and displaying at the same time the other recommended words of the first and second languages on a display unit 1420 of the device connected and/or installed to the device to which words are input.

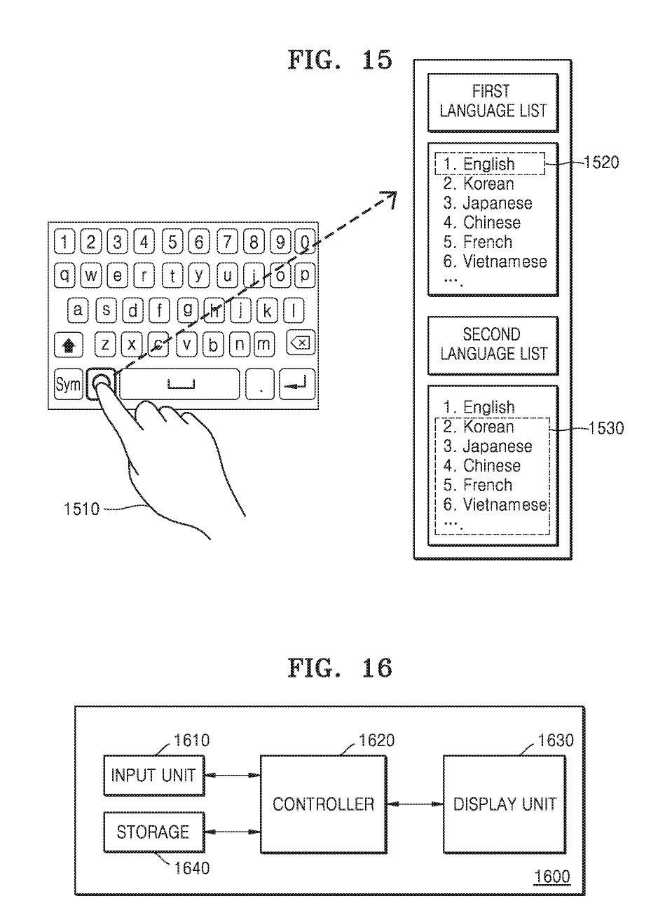

FIG. 15 illustrates a view of an example for selecting a first language and a second language, based on an external input, according to an embodiment of the present disclosure. A device may select the first language and the second language before inputting characters are input thereto. The selection of the first and second languages may include selection based on an external input 1510, selection based on a predetermined setting, and the like. The external input 1510 may include input by a keyboard, input by a mouse, input by a touch, input by voice recognition, and the like. For example, if English 1520 is selected as the first language by an external input, other languages 1530, except for English, may be selected as the second language.

Meanwhile, the predetermined setting may include a setting based on a default language set in a device, a user-specified setting for each application, a setting changed depending on a specific environment (for example, while roaming, a language of the device is changed to a language of a country where the roaming is performed), and the like.

FIG. 16 illustrates a functional block diagram of a configuration of a device 1600 for predicting and translating words, the device including a storage 1640 for storing subsets of a first language and a second language that are stored according to a predetermined setting, according to an example embodiment. Device 1600 also includes an input unit 1610, a controller, 1620, a display unit 1630.

According to an example embodiment, the first language 510 may be English, Czech, Vietnamese, Japanese, Japanese, German, or French. The second language 520 may be Korean, French, Greek, or Danish. The first language 510 is not the same as the second language 520. The first language 510 and the second language 520 may be configured via subsets with different combinations of the respective languages, and the subsets may be stored in storage 1640. A user may select one of the stored subsets to determine a language to be predicted and a language to be translated.

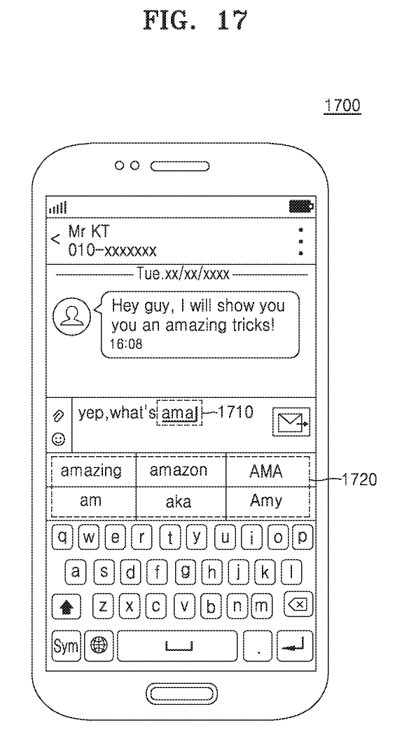

FIG. 17 illustrates a view of a configuration for providing recommended words in a complete form corresponding to incomplete characters when the incomplete characters are detected from input characters, according to an example embodiment. A device 1700 may provide recommended words in a complete form corresponding to incomplete characters 1710 to the input characters. The recommended words in the complete form may be provided by completing only the recommended words, provided in a plurality of forms according to a grammar of the language, or may be provided together with postpositions 1720 according to a grammar and a form of a sentence of the language.

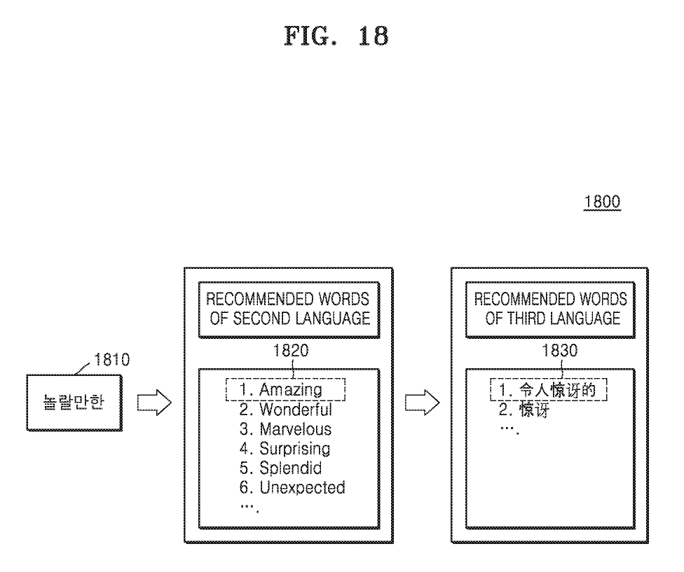

In FIG. 18 illustrates a view of an example of predicting and translating words of first, second, and third languages, according to an embodiment of the present disclosure. Device 1800 may translate translated recommended words of a second language into recommended words of a third language. The third language is different from the first and second languages. For example, if the first language is Korean 1810 and the second language is English 1820, the third language may be Chinese 1830. The translation into the recommended words of the third language may be a translation of at least one synonym or of one or more synonyms and/or similar words.

In addition, the device may display predicted recommended words of the first language, translated recommended words of the second language, and translated recommended words of the third language. At least one of the predicted recommended words of the first language may be displayed according to a predetermined setting, and at least one of the translated recommended words of the second and third languages may also be displayed according to a predetermined setting. In addition, the predicted recommended word of the first language and the translated recommended words of the second and third languages are preferably displayed on a single display screen.

Furthermore, according to an example embodiment, the term displaying may mean displaying on a display unit included in a device, or displaying on a display unit included in an external device connected and/or installed to a device. The external device connected and/or installed to the device may include a TV, a tablet PC, a laptop computer, a wearable device, and the like. For example, while the predicted recommended word of the first language and the translated recommended word of the second language are displayed on the display unit included in the device, the translated recommended word of the third language may be displayed on a display unit included in a wearable device.

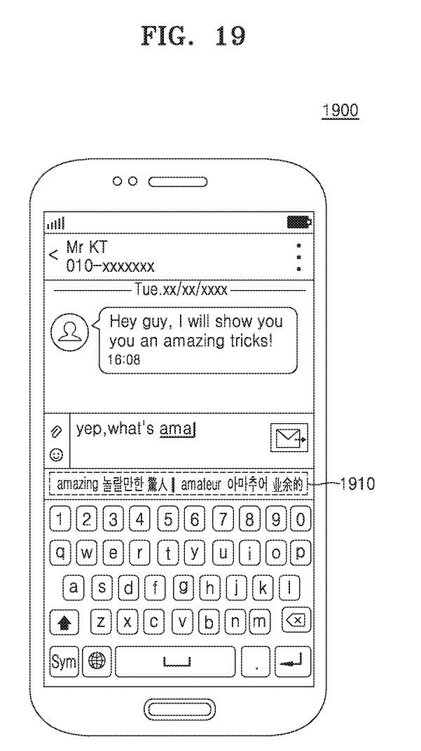

FIG. 19 illustrates a view of an example of simultaneously displaying predicted words and translated words of first, second, and third languages. Device 1900 depicts a view of a configuration for simultaneously displaying predicted recommended words of a first language and translated recommended words of second and third languages, according to an example embodiment. According to an example embodiment, a device 1900 may simultaneously display the predicted recommended words of the first language and the translated recommended words of the second and third languages in a portion 1910.

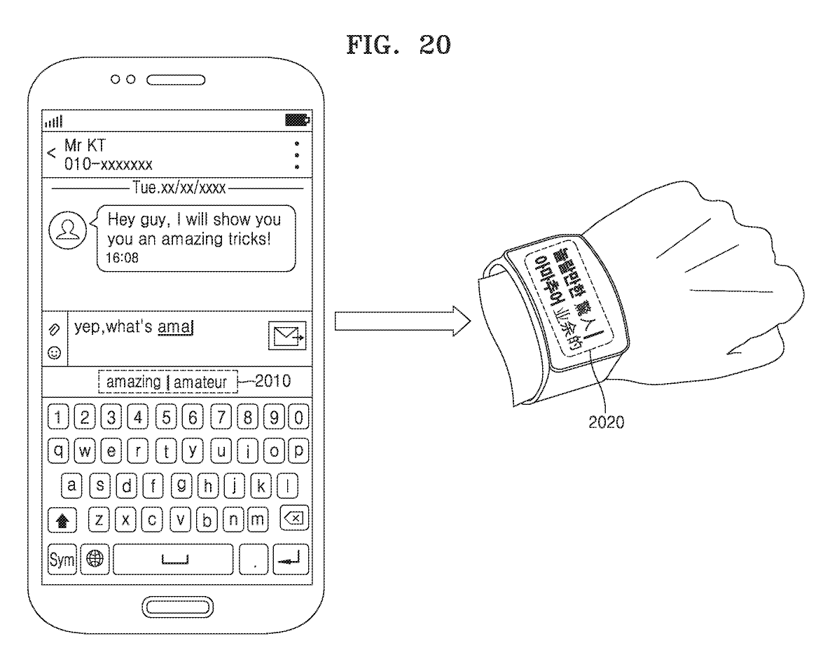

FIG. 20 illustrates a view of a configuration for displaying predicted words on a device on which characters are input and displaying translated words on an apparatus connected and/or installed to the device. With regard to FIG. 20, according to an example embodiment, the terminology simultaneous displaying may mean displaying recommended words of the first language on a display unit 2010 of the device to which words are input, and displaying at the same time recommended words of the second and third languages on a display unit 2020 of the device connected and/or installed to the device to which words are input.

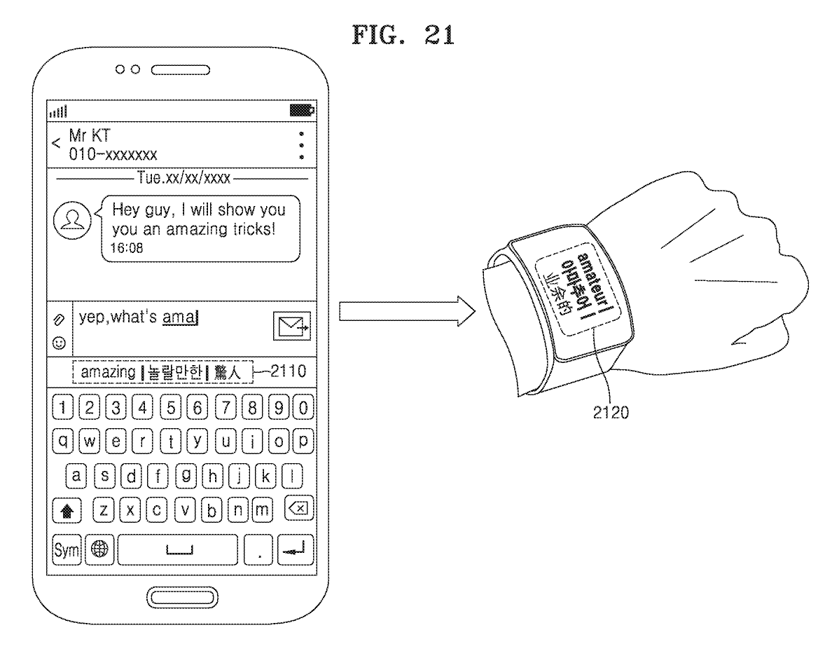

Furthermore, FIG. 21 illustrates a view of a configuration for displaying some predicted words and translated words on a device on which characters are input and displaying other predicted words and translated words on an apparatus connected and/or installed to the device. According to an example embodiment, the terminology simultaneous displaying may mean displaying one or more of the recommended words of the first language and one or more of the recommended words of the second and third languages on a display unit 2110 of the device on which words are input, and displaying at the same time the other recommended words of the first, second and third languages on a display unit 2120 of the device connected and/or installed to the device to which words are input.

Embodiments of the present disclosure and all functional operations described in the present specification may be implemented in digital electronic circuits, in computer software, firmware, or hardware including structures disclosed herein and their equivalents, or in one or more combinations thereof.

A non-transitory computer readable medium may be any usable medium that may be accessed by a computer, and may include any usable medium, such as, a volatile and non-volatile medium and a discrete type and non-discrete type medium. Also, the non-transitory computer readable medium may include all computer storing media and communication media. The computer storing medium may include any medium, such as, a volatile and non-volatile medium and a discrete type and non-discrete type medium that is realized by a method or technique for storing information, such as, a computer readable command, a data structure, a program module, or other data. The communication medium may include other data of modulated signal, such as, a computer readable command, a data structure, a program module, or a carrier signal, or other transmission mechanism, and an arbitrary information medium.

According to the present disclosure, by simultaneously displaying a predicted word and a translated word, the predicted word and the translated word may be immediately provided to a user.

It should be understood that the example embodiments described herein should be considered in a descriptive sense only and not for purposes of limitation. Descriptions of the features or aspects within each example embodiment should typically be considered as available for other similar features or aspects in other example embodiments.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of predicting and translating words, the method comprising:
receiving characters of a first language;
predicting one or more recommended words of the first language based on the received characters;
obtaining one or more recommended words of a second language by translating the predicted recommended words of the first language; and
displaying the one or more recommended words of the first language and the one or more recommended words of the second language.

2. The method of claim 1, wherein obtaining of the one or more recommended words of the second language comprises:
calculating a priority of the one or more recommended words of the second language; and
providing the one or more recommended words of the second language by aligning them according to the calculated priority.

3. The method of claim 1, wherein the one or more recommended words of the first language and the one or more recommended words of the second language are simultaneously displayed.

4. The method of claim 1, further comprising:
selecting the first and second languages.

5. The method of claim 4, wherein the selecting of the first and second languages comprises:
determining subsets of a combination of the first and second languages according to a predetermined setting.

6. The method of claim 1, wherein predicting of the one or more recommended words of the first language based on the received characters comprises providing the recommended words of the first language in a complete form when the received characters include incomplete characters.

7. The method of claim 1, wherein
obtaining the one or more recommended words of the second language comprises obtaining one or more recommended words of a third language by translating the recommended words of the second language, and
displaying the one or more recommended words of the first language and the one or more recommended words of the second language comprises displaying the one or more recommended words of the third language.

8. The method of claim 7, wherein
the one or more recommended words of the first language, the one or more recommended words of the second language, and the one or more recommended words of the third language are simultaneously displayed.

9. A device for predicting and translating words, the device comprising:
an input unit configured to receive characters of a first language;
a controller coupled to the input unit, wherein the controller is configured to:
predict one or more recommended words of the first language based on the received characters, and
obtain one or more recommended words of a second language by translating the predicted recommended words of the first language; and
a display unit coupled to the control, wherein the display unit is configured to display the one or more recommended words of the first language and the one or more recommended words of the second language.

10. The device of claim 9, wherein the controller is further configured to:
calculate priority of the one or more recommended words of the second language, and
provide the one or more recommended words of the second language by aligning them according to the calculated priority.

11. The device of claim 9, wherein the display unit is further configured to simultaneously display the one or more recommended words of the first language and the one or more recommended words of the second language.

12. The device of claim 9, wherein the controller is further configured to select the first language and the second language based on an external input received from the input controller.

13. The device of claim 12, further comprising:
a storage unit coupled to the control, wherein the storage unit is configured to store subsets of a combination of the first and second languages,
wherein the controller is further configured to determine the subsets of the combination of the first and second languages according to a predetermined setting.

14. The device of claim 9, wherein the controller is further configured to provide the recommended words of the first language in a complete form when the received characters include incomplete characters.

15. The device of claim 9, wherein
the controller is further configured to provide one or more recommended words of a third language by translating the recommended words of the second language, and
the display unit is further configured to display the one or more recommended words of the third language.

16. The device of claim 15, wherein: the one or more recommended words of the first language, the one or more recommended words of the second language, and the one or more recommended words of the third language are simultaneously displayed.

17. A non-transitory computer-readable medium comprising a program for predicting and translating words, the program comprising program code, that when executed by at least one processor, causes the at least one processor to:
receive characters of a first language;
predict one or more recommended words of the first language based on the received characters;
obtain one or more recommended words of a second language by translating the predicted recommended words of the first language; and
display the one or more recommended words of the first language and the one or more recommended words of the second language.

18. The non-transitory computer readable medium of claim 17, wherein the computer program further comprising program code that when executed causes the at least processor to:
calculate a priority of the one or more recommended words of the second language; and
provide the one or more recommended words of the second language by aligning them according to the calculated priority.

19. The non-transitory computer readable medium of claim 17, wherein the computer program further comprising program code that when executed causes the at least processor to:
simultaneously display the one or more recommended words of the first language and the one or more recommended words of the second language

20. The non-transitory computer readable medium of claim 17, wherein the computer program further comprising program code that when executed causes the at least processor to:
provide one or more recommended words of a third language by translating the recommended words of the second language, and
display the one or more recommended words of the third language.
